(19) United States
(12) Patent Application Publication
(10) Pub. No.: US 2002/0095667 A1
(43) Pub. Date: Jul. 18, 2002

(54) Optimizing compilation by forward store movement

(76) Inventor: Roch Georges Archambault, North York (CA)

Correspondence Address: Ronald L. Drumheller, Esq., 94 Teakettle Spout Road, Mahopac, NY, 10541, US

(21) Appl. No.: 09/965,587

(22) Filed: Sep. 27, 2001

(30) Foreign Application Priority Data
Sep. 27, 2000 (CA) 2,321,018

(51) Int. Cl. G06F 9/45

(52) U.S. Cl. 717/154; 717/157; 717/146

(57) ABSTRACT

An optimizing compiler includes a component for the determination of potential forward movements of store operations in the compilation of the computer software code. An intermediate representation of computer code is generated including a control flow graph, a data flow graph, a dominator tree, and a reaching defs table. These data structures are accessed to determine where in a conditional branch of code a store operation in the code may be moved to potentially increase efficiency in the execution of the compiled code. Tree structures corresponding to store operations are identified for possible movement, either entirely, or partially. Where a movement of a part of a tree structure is identified, temporary registers may be used to retain values of variables to enable the move to be carried out.

### FIELD OF THE INVENTION

The present invention is directed to an improvement in computing systems and in particular to computer systems for optimized compilation of computer code which provide for the forward movement of store operations during optimized compilation.

### BACKGROUND OF THE INVENTION

It is known in the art for compilers for computer code to optimize the code being compiled during compilation to provide for more efficient object code. It is known to move store operations within compiled in a source code to optimize the emitted object code. For example, in the prior art it is known to move store operations, where possible, out of loops. This scalar replacement technique is described, for example, in Advanced Compiler Design and Implementation, Steven S. Muchnik, ISBN 1-55860-320-4.

In such a prior art optimization, a movement of a store operation (an assignment to a variable) in a program is carried out where the same assignment to a variable is repeatedly executed during a loop in the program. However, there may be other store operations, in computer code which may be optimized where there are blocks of code that are not always executed.

It is therefore desirable to provide a computer system for the optimized compilation of computer code that may identify optimizations by movement of store operations in compiled code where the moved store operations may not always be executed.

### SUMMARY OF THE INVENTION

According to one aspect of the present invention, there is provided an improved system for optimizing the compilation of computer code.

According to another aspect of the present invention, there is provided an optimizing compiler for compiling computer code, the optimizing compiler including, means for identifying a store operation at an original location in the computer code as a candidate for forward movement, means for identifying a location in the code into which the candidate store operation may be moved, at which identified location the store operation will not always be executed, and means for comparing the nearest preceding definition point for the variables in the store operation at both the original location and at the identified location to determine whether the candidate store operation may be correctly moved forward to the identified location and to specify the type of movement available in the potential optimization.

According to another aspect of the present invention, there is provided the above optimizing compiler of in which the identifying means includes means for identifying a target block by selecting a side node in the intermediate representation.

According to another aspect of the present invention, there is provided an optimizing compiler utilizing an intermediate representation of computer code to be compiled, the intermediate representation including blocks of computer code represented in tree format, a data flow graph, a dominator tree, a post-dominator tree, a reaching defs table, and a control flow graph, the optimizing compiler including traversing means for traversing the control flow graph in breadth-first order commencing at an exit block for the computer code, and for traversing the tree representations of the code in reverse order, identifying means for identifying a target block into which a store operation reached in the traversal of the control flow graph may be moved, identifying means including means for defining a set of reached uses blocks for the reached store operation, the set of reached uses blocks being defined by accessing the data flow graph, means for traversing the dominator tree and for traversing the post-dominator tree to define the target block to be the first descendant, if any, of the reached store operation block which both dominates each block in the set of reached uses blocks, and does not post-dominate the reached store operation block, selecting means for determining whether the movement of the reached store operation to the target block may be correctly carried out and where the movement may be correctly carried out, adding an entry for the reached store operation and the target block to a store motion list, the selecting means including, means for comparing the reaching defs value for each load in the address expression of the reached store operation at its original location, with the reaching defs value for each load in the address expression of the reached store operation at the target block location, by accessing the reaching defs table, and means for signalling the addition of an entry to the store motion list where the comparison of the said reaching defs values match, and moving means for defining the movement of store operations on the store motion list to the respective locations of the target blocks on the store motion list, the moving means including, means to traverse the store motion list, means to determine the movement type for a store operation corresponding to an entry reached in the traversal of the store motion list, the movement type being determined by comparing the reaching defs values for each use in the right hand side expression of the reached store operation at its original location, with the reaching defs value for each use in the right hand side expression of the reached store operation at the target block location, by accessing the reaching defs table, and where the full set of values match, setting the movement type of the reached entry to designate a move of the entire store operation, where a subset of the values match, setting the movement type of the reached entry to designate a move of the partial right hand side of the store operation, storing in the store motion list the variables which are not able to be moved to the target block, and where none of the values match, setting the movement type of the reached entry to designate a move of the left hand side of the store operation.

According to another aspect of the present invention, there is provided the above optimizing compiler, further including means for carrying out the movement of store operations in accordance with the movement type indicated in the store motion list, including

means for traversing the store motion list,

means for altering the intermediate representation of the computer code in accordance with the information in the entry in the store motion list reached during traversal of the list, including

means to move the tree representation of the store operation in the reached entry to the target block of the reached entry where the movement type for the reached entry designates a move of the entire store operation,

means to generate temporary variables corresponding to the variables which are not able to be moved to the target block stored in the reached entry, to generate one or more replacement store operations in the intermediate code, at the location of the store operation of the reached entry, and to generate one or more replacement store operations in the intermediate code, at the target block location of the reached entry, whereby the replacement store operations permit the substitution of the temporary variables in the replacement store operations and permit the partial movement of the store operation of the reached entry to be made without altering the correctness of the intermediate representation, where the movement type for the reached entry designates a move of the partial right hand side of the store operation and

means to generate temporary variables corresponding to the variables in the right hand side of the store operation of the reached entry, to generate one or more replacement store operations in the intermediate code, at the location of the store operation of the reached entry, and to generate one or more replacement store operations in the intermediate code,

at the target block location of the reached entry, whereby the replacement store operations permit the substitution of the temporary variables in the replacement store operations of the reached entry, and the inclusion of the replacement store operations to be made without altering the correctness of the intermediate representation, where the movement type for the reached entry designates a move of the left hand side of the store operation.

According to another aspect of the present invention, there is provided the above optimizing compiler, further including means for updating the data flow graph in the intermediate representation to reflect any changes to the intermediate representation made in moving a store operation.

According to another aspect of the present invention, there is provided a method for determining a potential store forward optimization for the compilation of computer code, the method including the steps of,

(a) identifying a store operation at an original location in the computer code as a candidate for forward movement,

(b) identifying a location in the computer code into which the candidate store operation may be moved, at which identified location the store operation will not always be executed, and

(c) comparing the nearest preceding definition point for the variables in the store operation at both the original location and at the identified location to determine whether the candidate store operation may be correctly moved forward to the identified location and to specify the type of movement available in the potential optimization.

According to another aspect of the present invention, there is provided a method for determining a potential store forward optimization for the compilation of computer code, the compilation utilizing an intermediate representation of computer code to be compiled, the intermediate representation including blocks of computer code represented in tree format, a data flow graph, a dominator tree, a post-dominator tree, a reaching defs table, and a control flow graph, the method including the steps of

(a) traversing the control flow graph in breadth-first order commencing at an exit block for the computer code, and traversing the tree representations of the code in reverse order,

(b) identifying a target block into which a store operation reached in the traversal of the control flow graph may be moved, by defining a set of reached uses blocks for the reached store operation, the set of reached uses blocks being defined by accessing the data flow graph, and traversing the dominator tree and the post-dominator tree to define the target block to be the first descendant, if any, of the reached store operation block which both

dominates each block in the set of reached uses blocks, and

does not post-dominate the reached store operation block,

(c) determining whether the movement of the reached store operation to the target block may be correctly carried out and where the movement may be correctly carried out, adding an entry for the reached store operation and the target block to a store motion list, by comparing the reaching defs value for each load in the address expression of the reached store operation at its original location, with the reaching defs value for each load in the address expression of the reached store operation at the target block location, by accessing the reaching defs table, and signalling the addition of an entry to the store motion list where the comparison of the said reaching defs values match, and

(d) defining the movement of store operations on the store motion list to the respective locations of the target blocks on the store motion list, by traversing the store motion list,

(e) determining the movement type for a store operation corresponding to an entry reached in the traversal of the store motion list, the movement type being determined by comparing the reaching defs values for each use in the right hand side expression of the reached store operation at its original location, with the reaching defs value for each use in the right hand side expression of the reached store operation at the target block location, by accessing the reaching defs table, and

where the full set of values match, setting the movement type of the reached entry to designate a move of the entire store operation,

where a subset of the values match, setting the movement type of the reached entry to designate a move of the partial right hand side of the store operation, storing in the store motion list the variables which are not able to be moved to the target block, and

where none of the values match, setting the movement type of the reached entry to designate a move of the left hand side of the store operation.

According to another aspect of the present invention, there is provided the above method, further including steps for carrying out the movement of store operations in accordance with the movement type indicated in the store motion list, including the steps of

(a) traversing the store motion list,

(b) altering the intermediate representation of the computer code in accordance with the information in the entry in the store motion list reached during traversal of the list, including

(c) moving the tree representation of the store operation in the reached entry to the target block of the reached entry where the movement type for the reached entry designates a move of the entire store operation,

(d) generating temporary variables corresponding to the variables which are not able to be moved to the target block stored in the reached entry, generating one or more replacement store operations in the intermediate code, at the location of the store operation of the reached entry, and generating one or more replacement store operations in the intermediate code, at the target block location of the reached entry, whereby the replacement store operations permit the substitution of the temporary variables in the replacement store operations and permit the partial movement of the store operation of the reached entry to be made without altering the correctness of the intermediate representation, where the movement type for the reached entry designates a move of the partial right hand side of the store operation and

(e) generating temporary variables corresponding to the variables in the right hand side of the store operation of the reached entry, generating one or more replacement store operations in the intermediate code, at the location of the store operation of the reached entry, and generating one or more replacement store operations in the intermediate code, at the target block location of the reached entry, whereby the replacement store operations permit the substitution of the temporary variables in the replacement store operations of the reached entry, and the inclusion of the replacement store operations to be made without altering the correctness of the intermediate representation, where the movement type for the reached entry designates a move of the left hand side of the store operation.

According to another aspect of the present invention, there is provided the above method, further including the step of updating the data flow graph in the intermediate representation to reflect any changes to the intermediate representation made in moving a store operation.

According to another aspect of the present invention, there is provided a computer program product for the compilation of computer code, the computer program product including a computer usable medium having computer readable code means embodied in said medium, including computer readable program code means to carry out the method steps set out above.

Advantages of the present invention include the identification of potential optimizations in compilation where a store operation may be moved forward to a block of code that does not necessarily execute.

### BRIEF DESCRIPTION OF THE DRAWINGS

The preferred embodiment of the invention is shown in the drawings, wherein:

FIG. 1 is a schematic flowchart representing example computer software code potentially subject to an optimization of the preferred embodiment.

FIG. 2 is a schematic flowchart representing the example computer software code of FIG. 1 following an optimization of the preferred embodiment.

FIG. 3 is a schematic flowchart representing further example computer software code potentially subject to an optimization of the preferred embodiment.

FIG. 4 is a schematic flowchart representing the example computer software code of FIG. 3 following an optimization of the preferred embodiment.

In the drawings, the preferred embodiment of the invention is illustrated by way of example. It is to be expressly understood that the description and drawings are only for the purpose of illustration and as an aid understanding, and are not intended as a definition of the limits of the invention.

### DETAILED DESCRIPTION OF THE PREFERRED EMBODIMENT

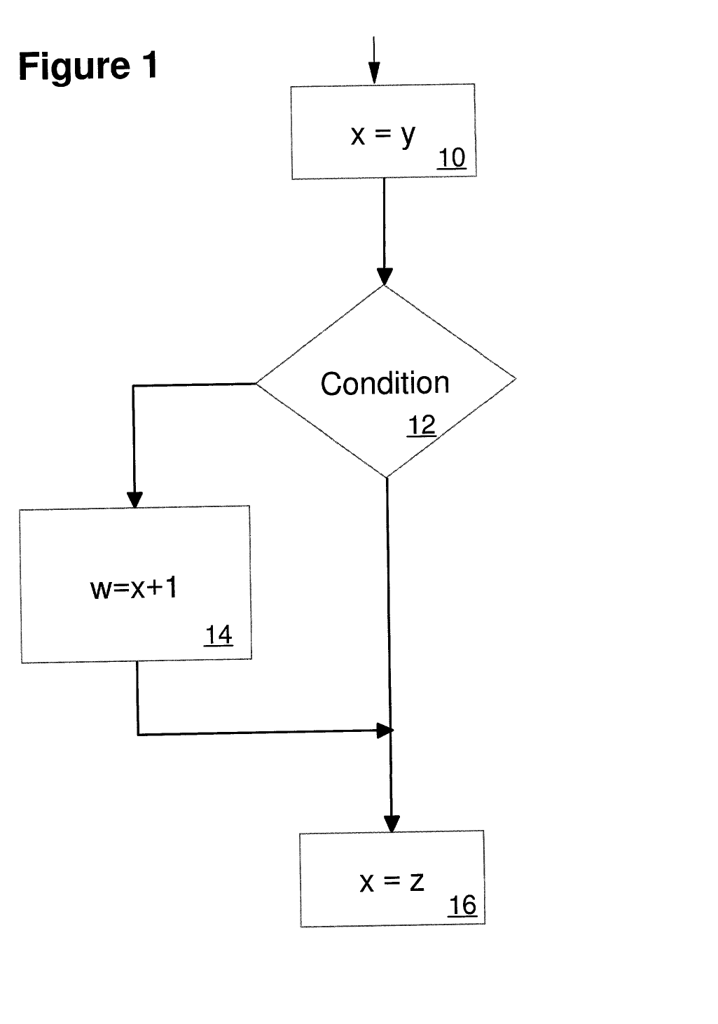

FIG. 1 illustrates, in a flow chart schematic format, computer software code that may be optimized in compilation by the preferred embodiment of the present invention. In the example of FIG. 1 there is shown statement 10, conditional branch 12, statement 14 and statement 16.

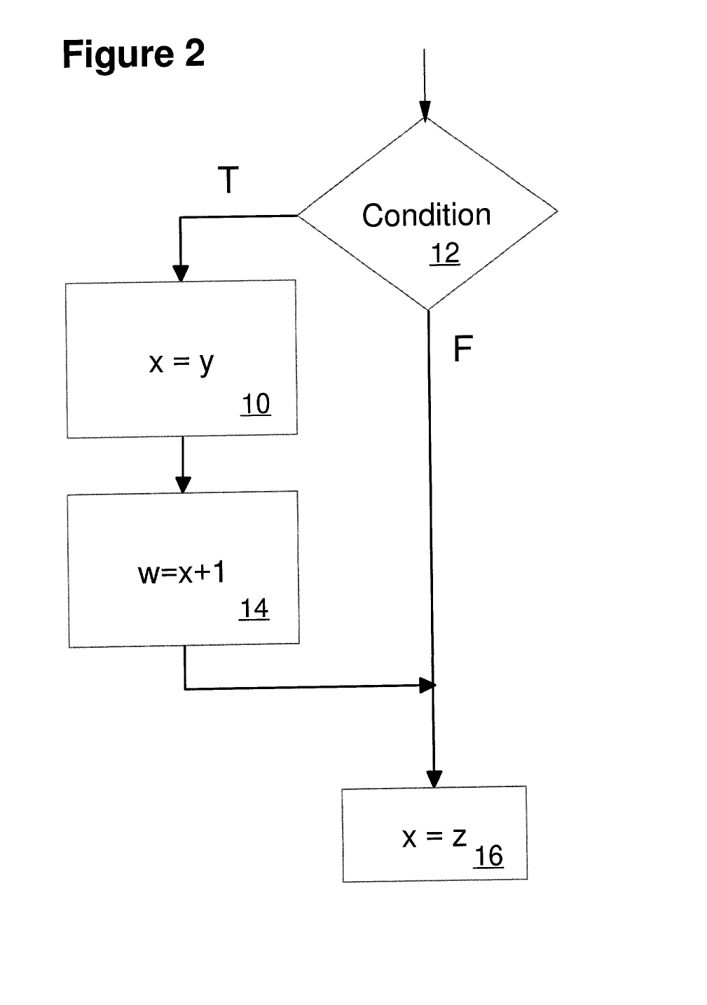

FIG. 2 illustrates in a schematic flow chart format, code following the movement of the store of statement 10. FIG. 2 shows conditional branch 12, statement 10 in a moved position, statement 14 and statement 16.

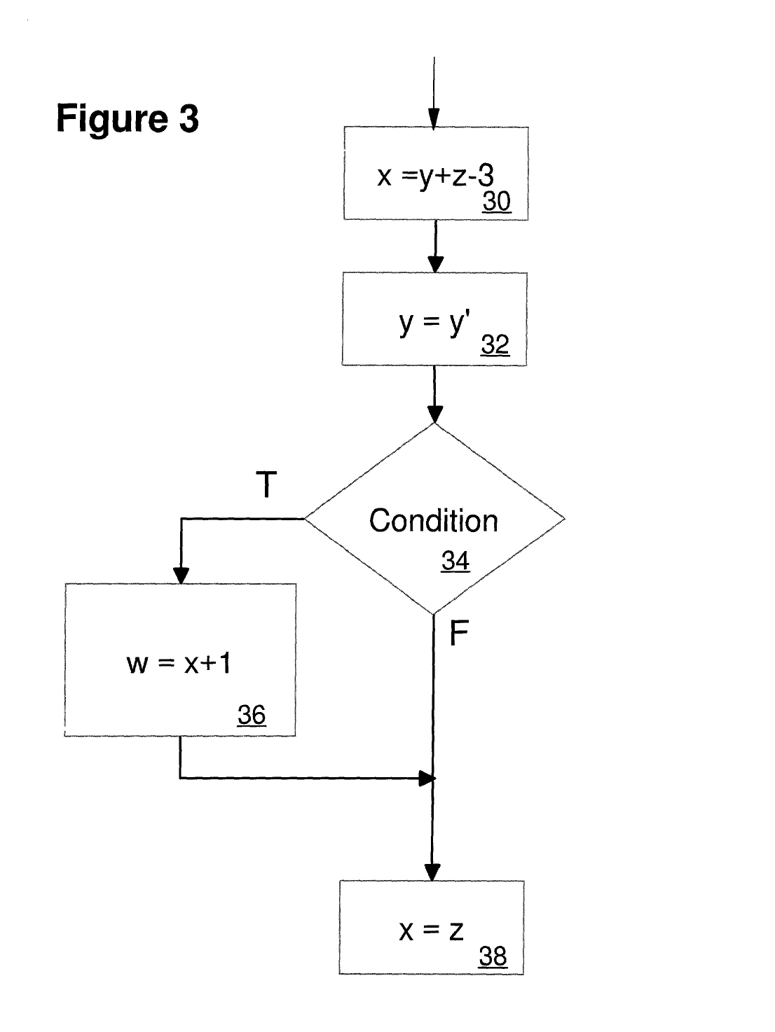

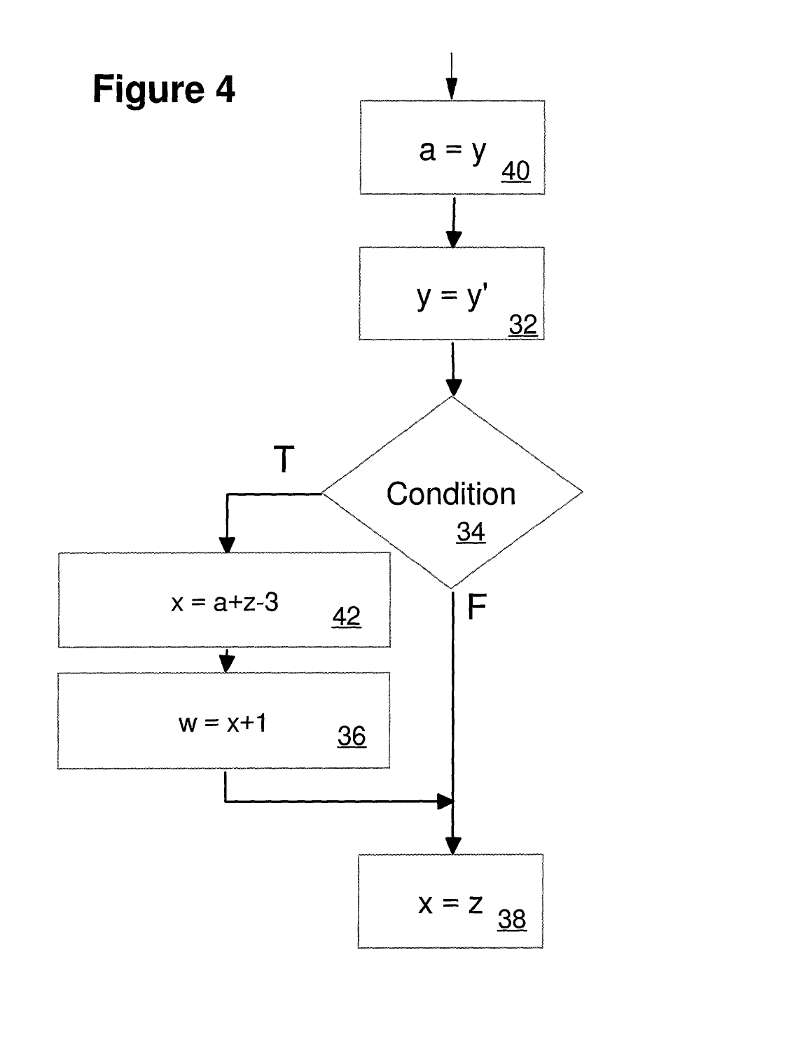

FIG. 3 illustrates, in a schematic flow chart format, a second example of computer code that may be subject to the optimization of the preferred embodiment. FIG. 3 includes statement 30, statement 32, conditional branch 34, statement 36 and statement 38. FIG. 4 illustrates, in a schematic flow chart format, the code of FIG. 3, as modified by the optimization of the preferred embodiment. FIG. 4 includes statement 40 and statement 42 as well as statements 32, 36, 38 and conditional branch 34.

The system of the preferred embodiment identifies where it is possible to carry out an optimization which includes the movement of a store operation forward into one branch of a conditional branch in the computer code being compiled. Turning to the example of FIG. 1, the example of statement 10 involves a store operation into variable x (“x=y”). Following conditional branch 12, there is a second store into variable x as shown in statement 16 (“x=z”). As shown in FIG. 1, where the condition in conditional branch 12 is true, there is a block of code executed in which variable x is used and or modified. In the example of FIG. 1, this block of code is shown by the store into x in statement 14 (“w=x+1”). Where the condition in conditional branch 12 is evaluated to false, however, the store into variable x shown in statement 16 is immediately executed. In this case, the store into x of statement 10 will immediately be overwitten by the store into x of statement 16. It is only where the other branch of the conditional branch is executed (i.e. statement 14 is executed) that it is required that statement 10 be executed.

For this reason, the optimization identified by the preferred embodiment moves the store operation of statement 10 into the branch corresponding to the true evaluation of the condition in -conditional branch 12. This is shown in FIG. 2 where statement 10 is shown at a location in one of the execution paths following conditional branch 12. The result of this forward store movement is to avoid the execution of the store represented by statement 10, where condition 12 evaluates to false.

Similarly, in FIG. 3 a store into variable x of the result of an operation that references variable y is shown in statement 30. In the example of FIG. 3, the statement stores the value of the expression “y+z−3” into x. In the example of FIG. 3, however, there is a subsequent store into variable y as shown in statement 32. For this reason, it is not possible to simply move statement 30 into the execution path for the true value of conditional branch 34, as was shown in the analogous example of FIG. 1 and FIG. 2.

For the example of the code shown in FIG. 3, the system of the preferred embodiment identifies an optimization that includes a move of store statement 30 after including new statement 40 in the code. Statement 40 stores the value of variable y into register a. Statement 30, which in this example is a store of expression “y+z−3”, is then replaced by statement 42. In this new statement 42, the value of “a+z−3” is stored to variable x, where “a” is the register holding the original value of variable y, as stored in statement 40. In this way, the potentially more costly execution of statement 30 is replaced by a less costly store to a register as represented by statement 40. Statement 42 is executed only when the condition in conditional branch 34 evaluates to true. In this way there is an optimization of the code generated by the compiler.

The system of the preferred embodiment carries out the move of the store operation, as described above, by accessing and modifying certain data structures. The implementation of the preferred embodiment makes use of an intermediate representation of the computer code generated by the compiler. Such representations, and the data structures set out below, are known to those skilled in the art. These data structures are described, for example, in Advanced Compiler Design and Implementation, Steven S. Muchnik, ISBN 1-55860-320-4.

The intermediate representation used in the preferred embodiment is a linked list of trees. In the preferred embodiment the root of a tree in linked list of the intermediate representation may represent a store operation. This permits the movement of a store operation within the intermediate representation to be achieved by moving the store operation root of the tree and all nodes in the tree, to a new position in the intermediate representation. The preferred embodiment also includes a control flow graph which represents the control flow relationships between basic blocks identified in computer code to be compiled. The nodes in the control flow graph represent basic blocks and the edges represent control flow edges between blocks.

Similarly, the intermediate representation includes a dominator tree which is derived from the control flow graph and represents the control flow dominator relationship between blocks in the program. A first block dominates a second block if the first block is always executed when the second block is executed. The intermediate representation also includes a post-dominator tree. A block B post-dominates a block A where if block A is executed, block B must also be executed.

A further intermediate representation data structure is the data flow graph which may be either the SSA representation or a more conventional use—definition chain representation of a data flow in the program. Both these approaches for data flow graph representations are known in the art.

A further data structure used in the preferred embodiment is a reaching defs table. In the preferred embodiment the intermediate representation of the code includes a table associated with each basic block of code. For a given symbol index and a block index the reaching defs table provides information as to the precise reaching def of that symbol at the start of that specified basic block. The reaching def (or reaching definition) for a particular variable is the position in the code where the variable is previously defined (as for example where a store into the variable occurs in the code).

As is described in more detail below, this reaching defs data structure is used in determining if a store operation of a variable can be moved forward into a block that is not always executed (a side node). The reaching def for that variable as defined in the reaching defs table must be the same at the target block as it is at the original block.

The preferred embodiment generates a data structure referred to as a store motion list. This data structure is used to keep track of store operations which are candidates to be moved. Each entry in the store motion list holds the following attributes of the candidate store operation statement:

1. A pointer to the store operation in the intermediate representation and data flow representation;

2. A target block is identified to which the store operation may potentially be moved.

3. The type of store movement is indicated from the following possibilities:

a) The entire tree representing the store statement is potentially to be moved to the target block (MoveTree).

b) Only the left hand side of the store operation can be moved to the target block. As part of the optimization a copy will be made of the value of the right hand side. This type of store movement is referred to as a move LHS store movement.

c) The tree representing the store operation can be moved to the target block by copying some parts of the right hand side expression of the store operation (move partial RHS).

4. A use list which lists the loads found in the right hand side expression of the store operation.

The operation of the optimization carried out by the preferred embodiment utilizes each of a control flow graph, a dominator tree, a post-dominator tree, a data flow representation and a reaching defs table for the code being compiled. The system of the preferred embodiment builds a store motion list potentially including each store operation represented in the intermediate representation of the code by carrying out a breadth-first traversal of the control flow graph from the exit block for the program being compiled. For each block reached in the traversal of the control flow graph, the trees of the intermediate representation contained in the block are traversed in backward order.

Each store operation represented in a tree reached during the traversal is analyzed to determine if it is a candidate for forward store movement as follows:

A potential target block for movement of the store is identified. The potential target block must be a side node in the intermediate representation, that is a block that does not always execute.

The target block (if any) is identified by defining the set of all blocks containing reached uses of that store (the set of reached uses blocks). This is carried out using the data flow graph of the intermediate representation. The data flow graph maintains information about uses of data and by traversing the data flow graph the set of blocks containing reached uses of the variable that is subject to the store operation is generated. The dominator tree and the post-dominator tree are accessed to find the first descendant block of the block of the store that both (a) dominates the set of reached uses blocks, and (b) does not post-dominate the block of the store.

In this way, a potential target block may be identified which dominates all reached uses of the store but which is not always executed when the candidate store operation is executed (i.e. is in a side node). If there is no such potential target block, then there is no forward store movement optimization possible for the store that is being considered and it is not a candidate store.

In the preferred embodiment, even where a potential block is determined, a store is not a candidate for movement if the store is to a volatile variable (i.e. to a variable with an attribute that prevents optimization, such as the volatile attribute in the language C++).

Further, the address expression of the store (if any) is analyzed to determine if it is able to be safely moved to the potential target block identified above. The system of the preferred embodiment verifies this constraint by analyzing the reaching defs table data structure. The reaching defs table values for each load in the address expression of the store is compared with the reaching defs values for those symbols at the target block. The reaching defs values must correspond. If the reaching defs values for the loads are different at the two locations, then in the preferred embodiment the store will not be a candidate to be moved to the potential target block identified. The store is therefore not added to the store motion list. It will be understood by those skilled in the art that a store operation may be added to the store motion list even where there is no complete match in reaching defs values. This alternative requires that there be a potential substitution of a temporary variable in the left hand side of the store in a manner similar to that described below with respect to the right hand side of the store.

If the candidate store operation reached in the traversal satisfies the constraints set out above then the store is added to the store motion list.

When the entire intermediate representation of the code to be compiled has been traversed, the store motion list will contain data representing all candidates for optimization by the forward store movement of the preferred embodiment. As indicated above, there are three types of movement: MoveLHS, MovePartialRHS, and MoveTree. At the time that a candidate store operation is added to the store motion list the kind of motion is specified by default to be a MoveLHS type of movement.

After building the store motion list, the system of the preferred embodiment traverses the store motion list itself to further specify which type of store movement is possible for each entry in the store motion list.

Where all operands in the right hand side in a store operation can be moved to a target block, then the kind of store movement is defined to be MoveTree. The reaching defs table is used to determine whether all operands in the right hand side expression are able to be moved to the target block. The reaching defs table entries for the operands for the store operation original location and for the target block location are compared and where each of those entries are the same, the entire tree may be moved.

This may be seen in reference to the example of FIG. 1 and FIG. 2. In that example, statement 10 will have been placed on the store motion list and the potential target block will be the block of statement 14. The reaching defs table entries for the block of statement 10 and the block of statement 14 will be the same for variable y, the right hand side of the store operation of statement 10. This indicates that the movement of the entire tree of representing statement 10 may be carried out in the optimization.

In for certain code, the analysis of the reaching defs table entries will indicate, however, that not all operands in the right hand side expression of the store operation can be moved to the target block. In this case, the reaching defs table entries are used to identify which operands may be copied. This is the case for those operands which do have the same reaching defs table values for the store operation and for the target block. All other operands are added to a data structure for the store operation defined as the used list. The kind of motion for the store in the store motion list is then defined to be MovePartialRHS.

FIGS. 3 and 4 represent code which is subject to a MovePartialRHS optimization. Statement 30 will be added to the store motion list and will have a target block corresponding to the block containing statement 36. In the traversal of the store motion list, the reaching defs entry for the block of statement 30 is compared with the reaching defs table for the block of statement 36. In this case, the inclusion of statement 32 in the code results in the reaching defs table entry for the block of statement 36 being different for variable y, than is the corresponding variable y value in the reaching defs table entry for the block of statement 30. As a result, variable y will be added to the used list, but not variable z (for which variable the reaching defs table entries are the same).

The preferred embodiment also determines if the store operation being moved is an automatic variable. In such a case, where the store movement is not MoveTree, the store is removed from the store motion list. This is done in the preferred embodiment because automatic variables reside in registers in the preferred embodiment and therefore movement of such a store will not reduce pathlinks in the emitted code.

The system of the preferred embodiment permits the optimizing compiler to traverse the store motion list. Where one of the forward store movement optimizations is determined to be of benefit, given the environment of the compiler, the compiler may carry out the movement of the store operations according to the defined type of store movement indicated for each entry in the store motion list.

If the movement type specified for the store operation in the motion store list is MoveTree then the entire tree representing the store operation is moved to the start of the target block. This is represented in the figures by the moved store of statement 10 that is copied entirely to a new location in the code shown in FIG. 2.

If the movement type is MovePartialRHS then a copy for each load in the used list is inserted into a temporary register. Each unsafe load in the right hand side expression is replaced with a corresponding load of the temporary register. The modified store tree is then moved to the start of the target block. This type of movement of a store is shown in FIGS. 3 and 4. In that case, the used list includes variable y (due to its use in statement 32). There is therefore a copy of variable to register a in statement 40. The moved statement 30 is modified to become statement 42 by replacing the reference to variable y to the load of register a.

If the type of movement defined is in the store motion list to be MoveLHS then the copy of the entire RHS expression is inserted into a temporary register before the original location of the store operation in the intermediate representation. The right hand side expression in the store tree is replaced with a load of the temporary register at the moved location. The modified store tree is moved to the start of the target block.

Note that the data flow graph for the code may be modified by the optimizations set out above. If a later optimization step in the compilation of the code requires the data flow representation to be accurate then the data flow representation must be updated to match the new code resulting from the optimization which includes the movement of the store operation.

The preferred embodiment provides for the optimization of compiled code by indicating where a movement of a store is possible. The decision of an optimizing compiler to carry out the optimization will depend on environment-dependent considerations specific to the compiler. The preferred embodiment provides a correctness test for the optimization, as opposed to a benefit test, which will be carried out by the optimizing compiler in ways know to those skilled in the art.

It will be apparent to those skilled in the art that the analysis and transformation set out above is carried out on a backward traversal for each store operation. In this way movement of stores that are dependent on each other may be carried out.

Although a preferred embodiment of the present invention has been described here in detail, it will be appreciated by those skilled in the art, that variations may be made thereto, without departing from the spirit of the invention or the scope of the appended claims.

The embodiments of the invention in which an exclusive property or privilege is claimed are defined as follows:

1. An optimizing compiler for compiling computer code, the optimizing compiler comprising,
means for identifying a store operation at an original location in the computer code as a candidate for forward movement,
means for identifying a location in the code into which the candidate store operation may be moved, at which identified location the store operation will not always be executed, and
means for comparing the nearest preceding definition point for the variables in the store operation at both the original location and at the identified location to determine whether the candidate store operation may be correctly moved forward to the identified location and to specify the type of movement available in the potential optimization.

2. An optimizing compiler utilizing an intermediate representation of computer code to be compiled, the intermediate representation comprising blocks of computer code and a control flow graph, the optimizing compiler comprising
traversing means for traversing the control flow graph in breadth-first order commencing at an exit block for the computer code,
identifying means for identifying a target block into which a store operation reached in the traversal of the control flow graph may be moved,
selecting means for determining whether the movement of the reached store operation to the target block may be correctly carried out and where the movement may be correctly carried out, adding an entry for the reached store operation and the target block to a store motion list, and
moving means for defining the movement of store operations on the store motion list to the respective locations of the target blocks on the store motion list.

3. The optimizing compiler of claim 2 in which the identifying means comprises means for identifying a target block by selecting a side node in the intermediate representation.

4. The optimizing compiler of claim 2 in which the intermediate representation further comprises a data flow graph, a dominator tree, and a post-dominator tree, and in which the identifying means further comprises
means for defining a set of reached uses blocks for the reached store operation, the set of reached uses blocks being defined by accessing the data flow graph,
means for traversing the dominator tree and for traversing the post-dominator tree to define the target block to be the first descendant, if any, of the reached store operation block which both
1. dominates each block in the set of reached uses blocks, and
2. does not post-dominate the reached store operation block.

5. The optimizing compiler of claim 2 in which the intermediate representation comprises a reaching defs table, and in which the selecting means comprises
means for comparing the reaching defs value for each load in the address expression of the reached store operation at its original location, with the reaching defs value for each load in the address expression of the reached store operation at the target block location, by accessing the reaching defs table, and
means for signalling the addition of an entry to the store motion list where the comparison of the said reaching defs values match.

6. The optimizing compiler of claim 5 in which the store motion list comprises data corresponding to a movement type for each entry in the list, and in which the moving means comprises,
means to traverse the store motion list,
means to determine the movement type for a store operation corresponding to an entry reached in the traversal of the store motion list, the movement type being determined by comparing the reaching defs values for each use in the right hand side expression of the reached store operation at its original location, with the reaching defs value for each use in the right hand side expression of the reached store operation at the target block location, by accessing the reaching defs table, and
where the full set of values match, setting the movement type of the reached entry to designate a move of the entire store operation,
where a subset of the values match, setting the movement type of the reached entry to designate a move of the partial right hand side of the store operation, storing in the store motion list the variables which are not able to be moved to the target block, and
where none of the values match, setting the movement type of the reached entry to designate a move of the left hand side of the store operation.

7. The optimizing compiler of claim 6, further comprising means for carrying out the movement of store operations in accordance with the movement type indicated in the store motion list, comprising
means for traversing the store motion list,
means for altering the intermediate representation of the computer code in accordance with the information in the entry in the store motion list reached during traversal of the list, comprising
means to move the entire representation of the store operation in the reached entry to the target block of the reached entry where the movement type for the reached entry designates a move of the entire store operation,
means to generate temporary variables corresponding to the variables which are not able to be moved to the target block stored in the reached entry, to generate one or more replacement store operations in the intermediate code, at the location of the store operation of the reached entry, and to generate one or more replacement store operations in the intermediate code, at the target block location of the reached entry, whereby the replacement store operations permit the substitution of the temporary variables in the replacement store operations and permit the partial movement of the store operation of the reached entry to be made without altering the correctness of the intermediate representation, where the movement type for the reached entry designates a move of the partial right hand side of the store operation and
means to generate temporary variables corresponding to the variables in the right hand side of the store operation of the reached entry, to generate one or more replacement store operations in the intermediate code, at the location of the store operation of the reached entry, and to generate one or more replacement store operations in the intermediate code, at the target block location of the reached entry, whereby the replacement store operations permit the substitution of the temporary variables in the replacement store operations of the reached entry, and the inclusion of the replacement store operations to be made without altering the correctness of the intermediate representation, where the movement type for the reached entry designates a move of the left hand side of the store operation.

8. The optimizing compiler of claim 7, further comprising means for updating a data flow graph in the intermediate representation to reflect any changes to the intermediate representation made in moving a store operation.

9. The optimizing compiler of claim 2, in which the intermediate representation of the code includes a tree representation and in which the traversal of the tree representation of code is carried out in a backward traversal order.

10. An optimizing compiler utilizing an intermediate representation of computer code to be compiled, the intermediate representation comprising blocks of computer code represented in tree format, a data flow graph, a dominator tree, a post-dominator tree, a reaching defs table, and a control flow graph, the optimizing compiler comprising
traversing means for traversing the control flow graph in breadth-first order commencing at an exit block for the computer code, and for traversing the tree representations of the code in reverse order,
identifying means for identifying a target block into which a store operation reached in the traversal of the control flow graph may be moved, identifying means comprising
means for defining a set of reached uses blocks for the reached store operation, the set of reached uses blocks being defined by accessing the data flow graph,
means for traversing the dominator tree and for traversing the post-dominator tree to define the target block to be the first descendant, if any, of the reached store operation block which both
(a) dominates each block in the set of reached uses blocks, and
(b) does not post-dominate the reached store operation block,
selecting means for determining whether the movement of the reached store operation to the target block may be correctly carried out and where the movement may be correctly carried out, adding an entry for the reached store operation and the target block to a store motion list, the selecting means comprising,
means for comparing the reaching defs value for each load in the address expression of the reached store operation at its original location, with the reaching defs value for each load in the address expression of the reached store operation at the target block location, by accessing the reaching defs table, and
means for signalling the addition of an entry to the store motion list where the comparison of the said reaching defs values match, and
moving means for defining the movement of store operations on the store motion list to the respective locations of the target blocks on the store motion list, the moving means comprising,
means to traverse the store motion list,
means to determine the movement type for a store operation corresponding to an entry reached in the traversal of the store motion list, the movement type being determined by comparing the reaching defs values for each use in the right hand side expression of the reached store operation at its original location, with the reaching defs value for each use in the right hand side expression of the reached store operation at the target block location, by accessing the reaching defs table, and
where the full set of values match, setting the movement type of the reached entry to designate a move of the entire store operation,
where a subset of the values match, setting the movement type of the reached entry to designate a move of the partial right hand side of the store operation, storing in the store motion list the variables which are not able to be moved to the target block, and
where none of the values match, setting the movement type of the reached entry to designate a move of the left hand side of the store operation.

11. The optimizing compiler of claim 10, further comprising means for carrying out the movement of store operations in accordance with the movement type indicated in the store motion list, comprising
means for traversing the store motion list,
means for altering the intermediate representation of the computer code in accordance with the information in the entry in the store motion list reached during traversal of the list, comprising
means to move the tree representation of the store operation in the reached entry to the target block of the reached entry where the movement type for the reached entry designates a move of the entire store operation,
means to generate temporary variables corresponding to the variables which are not able to be moved to the target block stored in the reached entry, to generate one or more replacement store operations in the intermediate code, at the location of the store operation of the reached entry, and to generate one or more replacement store operations in the intermediate code, at the target block location of the reached entry, whereby the replacement store operations permit the substitution of the temporary variables in the replacement store operations and permit the partial movement of the store operation of the reached entry to be made without altering the correctness of the intermediate representation, where the movement type for the reached entry designates a move of the partial right hand side of the store operation and
means to generate temporary variables corresponding to the variables in the right hand side of the store operation of the reached entry, to generate one or more replacement store operations in the intermediate code, at the location of the store operation of the reached entry, and to generate one or more replacement store operations in the intermediate code, at the target block location of the reached entry, whereby the replacement store operations permit the substitution of the temporary variables in the replacement store operations of the reached entry, and the inclusion of the replacement store operations to be made without altering the correctness of the intermediate representation, where the movement type for the reached entry designates a move of the left hand side of the store operation.

12. The optimizing compiler of claim 11, further comprising means for updating the data flow graph in the intermediate representation to reflect any changes to the intermediate representation made in moving a store operation.

13. A method for determining a potential store forward optimization for the compilation of computer code, the method comprising the steps of,
identifying a store operation at an original location in the computer code as a candidate for forward movement, identifying a location in the computer code into which the candidate store operation may be moved, at which identified location the store operation will not always be executed, and
comparing the nearest preceding definition point for the variables in the store operation at both the original location and at the identified location to determine whether the candidate store operation may be correctly moved forward to the identified location and to specify the type of movement available in the potential optimization.

14. A method for determining a potential store forward optimization for the compilation of computer code, the compilation utilizing an intermediate representation of computer code to be compiled, the intermediate representation comprising blocks of computer code and a control flow graph, the method comprising the steps of
traversing the control flow graph in breadth-first order commencing at an exit block for the computer code,
identifying a target block into which a store operation reached in the traversal of the control flow graph may be moved,
determining whether the movement of the reached store operation to the target block may be correctly carried out and where the movement may be correctly carried out, adding an entry for the reached store operation and the target block to a store motion list, and
defining the movement of store operations on the store motion list to the respective locations of the target blocks on the store motion list.

15. The method of claim 14 in which the identifying step identifies a target block by selecting a side node in the intermediate representation.

16. The method of claim 14 in which the intermediate representation further comprises a data flow graph, a dominator tree, and a post-dominator tree, and in which the identifying step further comprises the steps of
defining a set of reached uses blocks for the reached store operation, the set of reached uses blocks being defined by accessing the data flow graph,
traversing the dominator tree and traversing the post-dominator tree to define the target block to be the first descendant, if any, of the reached store operation block which both
(a) dominates each block in the set of reached uses blocks, and
(b) does not post-dominate the reached store operation block.

17. The method of claim 14 in which the intermediate representation comprises a reaching defs table, and in which the selecting step comprises the steps of
comparing the reaching defs value for each load in the address expression of the reached store operation at its original location, with the reaching defs value for each load in the address expression of the reached store operation at the target block location, by accessing the reaching defs table, and
signalling the addition of an entry to the store motion list where the comparison of the said reaching defs values match.

18. The method of claim 17 in which the store motion list comprises data corresponding to a movement type for each entry in the list, and in which the moving step further comprises the steps of,
traversing the store motion list,
determine the movement type for a store operation corresponding to an entry reached in the traversal of the store motion list, the movement type being determined by comparing the reaching defs values for each use in the right hand side expression of the reached store operation at its original location, with the reaching defs value for each use in the right hand side expression of the reached store operation at the target block location, by accessing the reaching defs table, and
where the full set of values match, setting the movement type of the reached entry to designate a move of the entire store operation,
where a subset of the values match, setting the movement type of the reached entry to designate a move of the partial right hand side of the store operation, storing in the store motion list the variables which are not able to be moved to the target block, and
where none of the values match, setting the movement type of the reached entry to designate a move of the left hand side of the store operation.

19. The method of claim 18, further comprising the step of carrying out the movement of store operations in accordance with the movement type indicated in the store motion list, comprising the following steps
traversing the store motion list,
altering the intermediate representation of the computer code in accordance with the information in the entry in the store motion list reached during traversal of the list, comprising the steps of
moving the entire representation of the store operation in the reached entry to the target block of the reached entry where the movement type for the reached entry designates a move of the entire store operation,
generating temporary variables corresponding to the variables which are not able to be moved to the target block stored in the reached entry, generating one or more replacement store operations in the intermediate code, at the location of the store operation of the reached entry, and generating one or more replacement store operations in the intermediate code, at the target block location of the reached entry, whereby the replacement store operations permit the substitution of the temporary variables in the replacement store operations and permit the partial movement of the store operation of the reached entry to be made without altering the correctness of the intermediate representation, where the movement type for the reached entry designates a move of the partial right hand side of the store operation and
generating temporary variables corresponding to the variables in the right hand side of the store operation of the reached entry, generating one or more replacement store operations in the intermediate code, at the location of the store operation of the reached entry, and generating one or more replacement store operations in the intermediate code, at the target block location of the reached entry, whereby the replacement store operations permit the substitution of the temporary variables in the replacement store operations of the reached entry, and the inclusion of the replacement store operations is made without altering the correctness of the intermediate representation, where the movement type for the reached entry designates a move of the left hand side of the store operation.

20. The method of claim 19, further comprising the step of updating a data flow graph in the intermediate representation to reflect any changes to the intermediate representation made in moving a store operation.

21. The method of claim 14, in which the intermediate representation of the code includes a tree representation and in which the traversal of the tree representation of code is carried out in a backward traversal order.

22. A method for determining a potential store forward optimization for the compilation of computer code, the compilation utilizing an intermediate representation of computer code to be compiled, the intermediate representation comprising blocks of computer code represented in tree format, a data flow graph, a dominator tree, a post-dominator tree, a reaching defs table, and a control flow graph, the method comprising the steps of
traversing the control flow graph in breadth-first order commencing at an exit block for the computer code, and traversing the tree representations of the code in reverse order,
identifying a target block into which a store operation reached in the traversal of the control flow graph may be moved, by defining a set of reached uses blocks for the reached store operation, the set of reached uses blocks being defined by accessing the data flow graph, and traversing the dominator tree and the post-dominator tree to define the target block to be the first descendant, if any, of the reached store operation block which both
(a) dominates each block in the set of reached uses blocks, and
(b) does not post-dominate the reached store operation block,
determining whether the movement of the reached store operation to the target block may be correctly carried out and where the movement may be correctly carried out, adding an entry for the reached store operation and the target block to a store motion list, by
comparing the reaching defs value for each load in the address expression of the reached store operation at its original location, with the reaching defs value for each load in the address expression of the reached store operation at the target block location, by accessing the reaching defs table, and
signalling the addition of an entry to the store motion list where the comparison of the said reaching defs values match, and
defining the movement of store operations on the store motion list to the respective locations of the target blocks on the store motion list, by
traversing the store motion list,
determining the movement type for a store operation corresponding to an entry reached in the traversal of the store motion list, the movement type being determined by comparing the reaching defs values for each use in the right hand side expression of the reached store operation at its original location, with the reaching defs value for each use in the right hand side expression of the reached store operation at the target block location, by accessing the reaching defs table, and
where the full set of values match, setting the movement type of the reached entry to designate a move of the entire store operation,
where a subset of the values match, setting the movement type of the reached entry to designate a move of the partial right hand side of the store operation, storing in the store motion list the variables which are not able to be moved to the target block, and
where none of the values match, setting the movement type of the reached entry to designate a move of the left hand side of the store operation.

23. The method of claim 22, further comprising steps for carrying out the movement of store operations in accordance with the movement type indicated in the store motion list, comprising the steps of
traversing the store motion list,
altering the intermediate representation of the computer code in accordance with the information in the entry in the store motion list reached during traversal of the list, comprising
moving the tree representation of the store operation in the reached entry to the target block of the reached entry where the movement type for the reached entry designates a move of the entire store operation,
generating temporary variables corresponding to the variables which are not able to be moved to the target block stored in the reached entry, generating one or more replacement store operations in the intermediate code, at the location of the store operation of the reached entry, and generating one or more replacement store operations in the intermediate code, at the target block location of the reached entry, whereby the replacement store operations permit the substitution of the temporary variables in the replacement store operations and permit the partial movement of the store operation of the reached entry to be made without altering the correctness of the intermediate representation, where the movement type for the reached entry designates a move of the partial right hand side of the store operation and
generating temporary variables corresponding to the variables in the right hand side of the store operation of the reached entry, generating one or more replacement store operations in the intermediate code, at the location of the store operation of the reached entry, and generating one or more replacement store operations in the intermediate code, at the target block location of the reached entry, whereby the replacement store operations permit the substitution of the temporary variables in the replacement store operations of the reached entry, and the inclusion of the replacement store operations to be made without altering the correctness of the intermediate representation, where the movement type for the reached entry designates a move of the left hand side of the store operation.

24. The method of claim 23, further comprising the step of updating the data flow graph in the intermediate representation to reflect any changes to the intermediate representation made in moving a store operation.

25. A computer program product for the compilation of computer code, the computer program product comprising a computer usable medium having computer readable code means embodied in said medium, comprising computer readable program code means to carry out the method steps of claim 13.
